(19) United States
(12) Patent Application Publication
(10) Pub. No.: US 2004/0060231 A1
(43) Pub. Date: Apr. 1, 2004

(54) Floral transport system

(76) Inventor: Robert J. Hawley, Woburn, MA (US)

Correspondence Address: Richard C. Litman, LITMAN LAW OFFICES, LTD., P.O. Box 15035, Arlington, VA, 22215, US

(21) Appl. No.: 10/259,426

(22) Filed: Sep. 30, 2002

(51) Int. Cl. A01G 5/00; A47G 7/00

(52) U.S. Cl. 47/41.01

(57) ABSTRACT

An adjustable, modular transport system for safely moving floral arrangements for funerals and other events by means of a truck or van. The system includes a base unit of various lengths having an elongated base with groove-forming rails mounted on the sides of the base along the length thereof to form respective inward facing grooves. The base floor and the inward facing grooves form a slot. The rails contained bores spaced therealong at equal intervals to accommodate spacers having corresponding rods extending downward therefrom. The slot accommodates a conventional floral basket base extension. A number of baskets may be inserted and separated by the spacers installed therebetween. The slot accommodate a base support for a flower pot or vase holder and of the same dimensions as that of the conventional basket base. The flower vase holder is tubular in shape, vertically mounted on an end.

### BACKGROUND OF THE INVENTION

1. Field of the Invention

The present invention relates to transport securing devices. More particularly, the present invention relates to holders for floral arrangements in baskets and vases and securing structure for transportation of the floral arrangements in a delivery vehicle.

2. Description of the Related Art

It is known to provide apparatus for assisting in transporting floral arrangements in baskets or vases. These leave much to be desired in securing the basket or vase so as to avoid spillage of water and damage to the floral arrangement. It would b desirable to provide a modular system for transporting a large, variable number of floral arrangements in baskets or vases for occasions such as funerals while avoiding spillage or damage during transport, such as in a van or truck.

U.S. Pat. No. 1,088,347, issued Feb. 24, 1914, to Koehler describes bracing for cargo in a car which includes wooden slats that can be variably arranged so as to prevent the contents of the vehicle from shifting during transport.

U.S. Pat. No. 2,646,903, issued Jul. 28, 1953, to Draper, Jr., describes an adjustable holding device capable of holding a vase of any size in an upright position during transport.

U.S. Pat. No. 3,606,004, issued Sep. 20, 1971, to Fruehwirth, describes a plant package and shipping container for potted plants.

U.S. Pat. No. 3,881,674, issued May 6, 1975, to Green, III, describes a flower delivery holder having a mouth which adjusts to accept a variety of bases and is intended for the purpose of safely transporting floral arrangements.

U.S. Pat. No. 4,226,348, issued Oct. 7, 1980, to Dottor et al., describes a grocery bag holder for the trunk of an automobile.

U.S. Pat. No. 4,302,025, issued Nov. 24, 1981, to Weddle, describes a cart having longitudinal channels and adjustable transverse rails for providing secure compartments for floral baskets or pots during transportation.

U.S. Pat. No. 6,368,036 B1, issued Apr. 9, 2002, to Vario, describes a system for packing plant nursery items on a truck.

None of the above inventions and patents, taken either singularly or in combination, is seen to describe the instant invention as claimed. Thus, a floral transport system solving the aforementioned problems is desired.

### SUMMARY OF THE INVENTION

The present invention is an adjustable, modular transport system for safely moving floral arrangements for funerals and other events by means of a truck or van. These arrangements are moved unwrapped in containers having water therein. Most arrangements are fragile and unstable in a moving vehicle. The system includes a base unit of various lengths to accommodate vehicles of various size. The base unit has an elongated base with groove-forming rails mounted on the sides of the base along the length thereof to form respective inward facing grooves. The base floor and the inward facing grooves form a slot having the length of the base unit. The rails contain pairs of equally spaced bores therealong at equal intervals to accommodate spacers having corresponding rods extending downward therefrom so as to be square to the rails when installed.

The slot accommodates a conventional floral basket base extension in the manner of a tongue and groove arrangement such that the basket may be inserted and slid within said rails while preventing upward and tipping motion of the basket. A number of baskets may be inserted and separated by the spacers installed therebetween. The slot may accommodate a base support for a flower pot or vase holder and of the same dimensions as that of the conventional basket base. The flower vase holder is tubular in shape, vertically mounted on an end, and has diametrically opposed vertical slots extending downward from the upper lip of the vase holder. The desired number of vase or pot holders may be installed in the slot of the elongated base in the same manner as the flower baskets. The vase or pot holder may have a spacer installed therein so as to fit a particular pot or vase securely during transport. The elongated base may be the same width for receiving flower baskets and vase holders or a narrower elongated base may be used for vase holders having smaller support bases in order to save space.

Accordingly, it is a principal object of the invention to provide a system for transporting a number of floral arrangements in a truck or van while protecting from tipping or damaging the floral arrangements.

It is another object of the invention to provide a system as above which securely holds conventional floral baskets.

It is a further object of the invention to provide a system as above which includes removable spacers for insertion between baskets so as to hold them in place.

Still another object of the invention is to provide a system as above which includes a flower pot or vase holder mounted on a base of the same dimensions as that of the conventional floral baskets for mounting in the same manner.

Yet another object of the invention is to provide a system as above having an elongated base floor and groove forming side rails which grooves face inwardly so as to form a slot therewith to receive a number of the bases of flower baskets and vase holders for transport.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a floral transport system for flower baskets according to the present invention.

FIG. 2 is a perspective view of the floral transport system of FIG. 1 having vase or pot holders.

FIG. 3 is a perspective view of a spacer useful in the transport system of FIGS. 1 and 2.

FIG. 4 is a perspective view of the conventional flower basket useful in the present invention.

FIG. 5 is a perspective view of a base mounted vase or pot holder according to the present invention.

Similar reference characters denote corresponding features consistently throughout the attached drawings.

### DETAILED DESCRIPTION OF THE PREFERRED EMBODIMENTS

The present invention is a floral transport system for maintaining a number of floral arrangements in water containing flower baskets and vases in a stable position during transport in a truck or van for delivery to a funeral or special event.

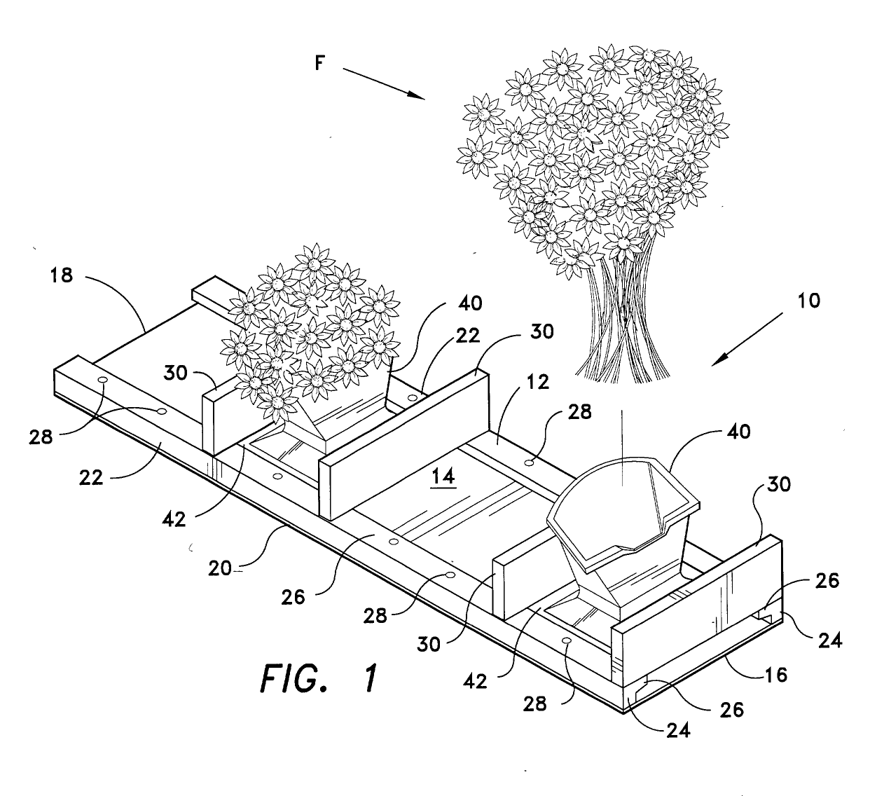

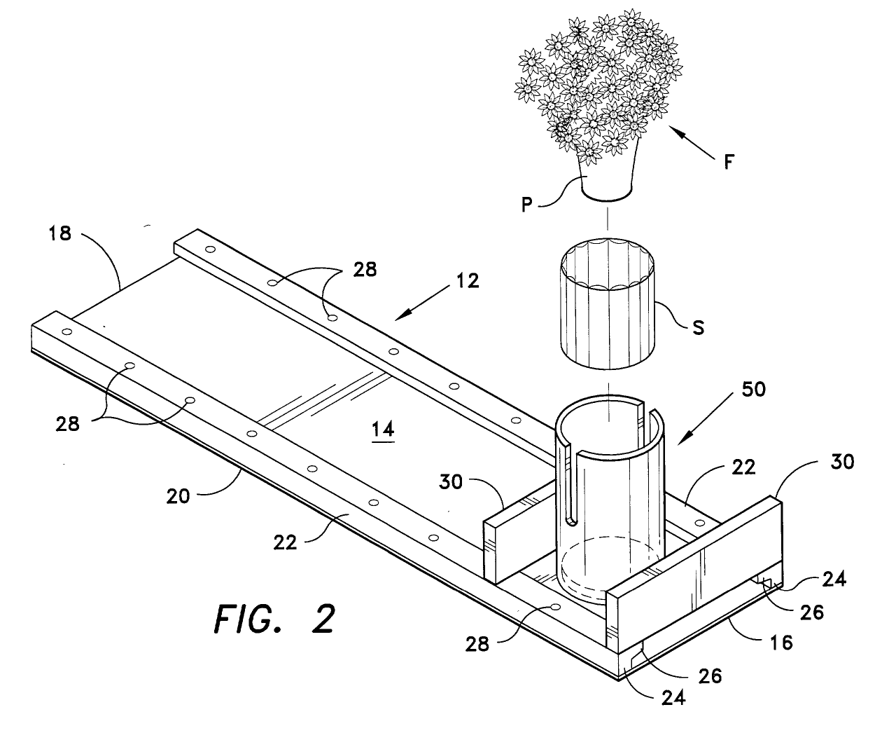

Referring to the FIGS. 1 and 2 there are shown perspective views of the inventive floral transport system containing floral arrangement baskets and a vase or pot holder respectively as held in the side rails and separated by spacers. The floral transport system of the present invention is generally referred to by 10. System 10 has a base unit 12 having an elongated floor 14 having a top surface and a bottom surface an having a front end 16, a rear end 18, and opposing sides 20.

Groove forming rails 22 extend along each side of elongated floor 14 along the top surface thereof, the rails having lower portion 24 and an upper portion 26 extending inward so as to form mutually facing grooves to form a slot with the floor 14. Rails 22 also have receiving bores 28 in equally spaced pairs spaced along each rail and directed perpendicularly downward through rails 22. Spacers 30 are spaced along between rails 22 at receiving bores 28 as desired.

As seen in FIG. 1, spacers 30 separate baskets 40 and protect flowers F while restraining movement of the baskets 40 along the base unit 12. As seen in FIG. 2, vase spacer S allows for a snug fit of vase or pot P into holder 50 while flowers F are protected from damage and movement by spacers 30.

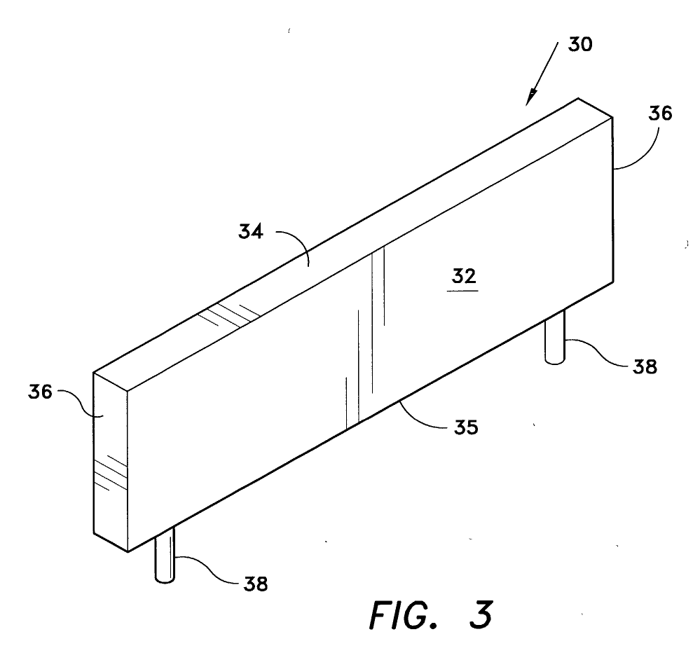

Referring to FIG. 3, there is shown a perspective view of the floral arrangement spacer 30. Spacer 30 is planar, having front and rear surfaces 32, and upper edge 34, a lower edge 35 and ends 36. Rods 38 extend vertically downward from lower edge 35 and spaced so as to perpendicularly engage base unit 12 by means of insertion of rods 38 into base unit rail receiving bores 28 (see FIGS. 1 and 2).

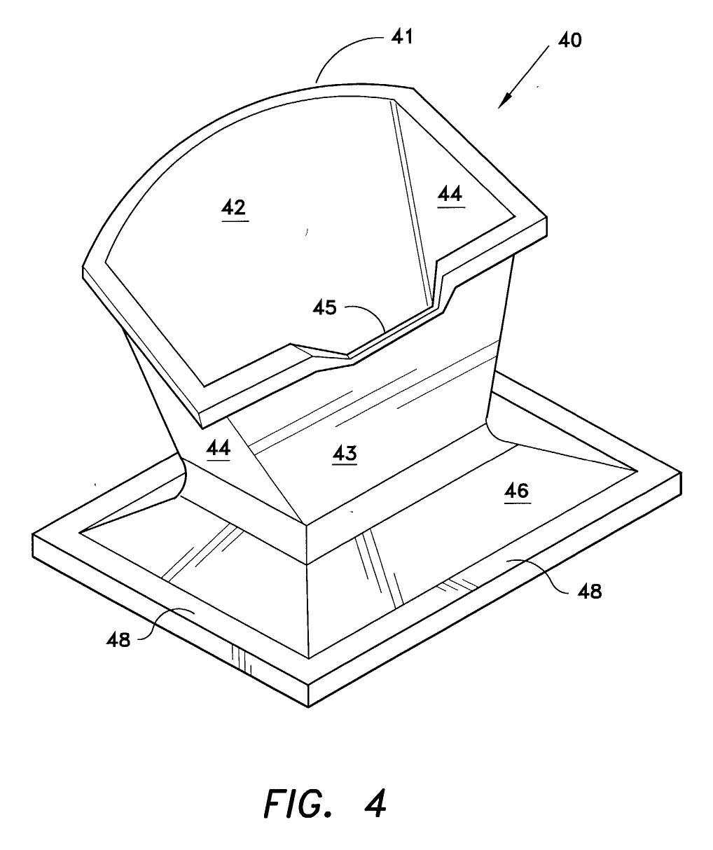

FIG. 4 is a perspective view of a conventional floral arrangement basket 40. Basket 40 has an upper edge 41 extending around the top thereof, an elevated rear wall 42, a front wall 43, side walls 44 having their portions of upper edge 41 sloping downward from the upper edge of elevated rear wall 42 to the upper edge of front wall 43. The front wall 43 has a lowered lip portion 45 centrally located along the upper edge of front wall 43. Walls 44 are sloped inward toward closed basket base 46 to form a receptacle for flowers F (see FIG. 1). Base 46 has an extended edge 48 surrounding its lower portion, the length and thickness being of such dimensions as to engagingly slide into the slot formed by opposing grooves of rails 22 of base unit 12 (see FIGS. 1 and 2) to provide support from tipping to basket 40. The baskets may thus be inserted into and slid along the slot one by one to form a row of baskets held therein. A ¼ inch lateral clearance should be provided whithin the slot to provide for ease in inserting the basket base therein.

The pairs of bores in rails 22 are preferably spaced along the rails at a distance of one-half the space between said rods 38 on said spacer, whereby each basket is located between a pair of spacers and a space is maintained between each of said baskets by their respective pair of spacers.

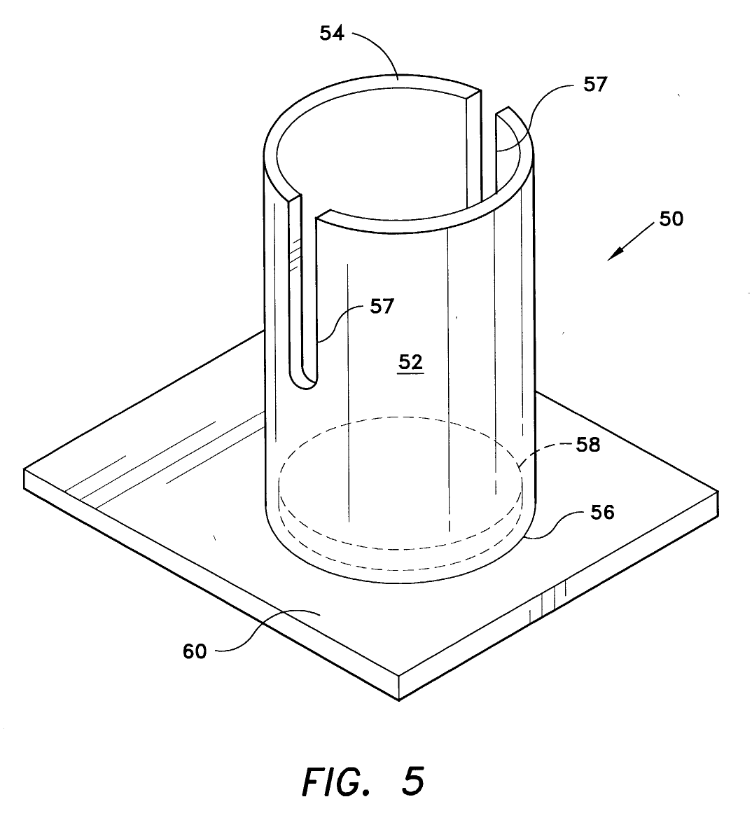

Referring to FIG. 5, there is shown a pot or vase holder 50 is useful in the present invention. Vase holder 50 has a cross sectional size to receive vase or pot P (see FIG. 2), and having a truncated tubular wall 52, an upper edge 54, and a lower edge 56. Tubular wall 52 has diametrically opposed vertical slots 57 extending downwardly any desired length from upper edge 54 for receiving any handles or pouring spouts on vases or other flower holders. The diameter defined by the slots is preferably perpendicular to the rails 22. Pot or vase holder 50 may have an inner base support centrally attached to the top surface of rectangular base 60 to receive and provide support 58 in the connection of tubular wall 52 at its lower edge 56. Base 60 has a length and thickness of such dimensions as to engagingly slide into the opposing grooves of rails 22 of base unit 12 (see FIGS. 1 and 2) to provide support from tipping to pot or vase P.

In operation, floral arrangement containing baskets 40 are inserted in the grooves of base unit 12 and slid to desired points. Spacers 30 are then inserted into base unit rail receiving bores 28, the baskets 40 being located such that the spacers 30 separate each flower arrangement and are located at each end of the series of baskets 40 for lateral support during transport. Vase or pot holders 50 containing vases or pots P with appropriate spacers S are similarly installed in base unit 12 for transport.

The base unit 12 and groove forming side rails 22 may be made of wood or other appropriate material. The tubular wall of the vase or pot holder 50 may be plastic tubing or other appropriate material and the base may be made of wood or plastic. The vase or pot holder 50 may be molded in an integral unit if desired.

It is to be understood that the present invention is not limited to the embodiments described above, but encompasses any and all embodiments within the scope of the following claims

I claim:

1. A floral transport system comprising:
a generally rectangular base unit comprising:
a generally rectangular base unit floor having a top surface, a bottom surface, a front end, a rear end and parallel sides; and
a pair of groove forming rails extending along respective sides;
a plurality of spaced, removable spacers extending between and perpendicular to said groove forming rails;
said groove forming rails each having a lower portion attached to said floor and an upper portion extending inward from said sides forming inward facing grooves so as to form a slot between said base unit floor and said groove forming rails;
said groove forming rails each having equally spaced pairs of vertical bores extending through said rails; and
said spacers having rods extending vertically downward therefrom and spaced to be received in one of said pairs of vertical bores.

2. The floral transport system of claim 1, wherein said grooves are spaced so as to form said slot so as to receive the extended edge of the base of a conventional floral arrangement basket; whereby a plurality of said baskets may be inserted one by one into and slid along said slot to form row of said baskets.

3. The floral transport system of claim 2, wherein said pairs of bores are so spaced as to allow said spacers to be inserted between each basket so as to space the baskets and their floral arrangements.

4. The floral transport system of claim 3, wherein pairs of bores are spaced along said rail at a distance of one-half the space between said rods on said spacer, whereby each said basket is located between a pair of spacers and a space is maintained between each of said baskets by their respective pair of spacers.

5. The floral transport system of claim 4, wherein said spacers are planar in configuration, each having an upper edge, a lower edge, and opposing ends, said rods extending downward from said lower edge, said spacers extending upward so as to separate said baskets and their contents.

6. The floral transport system of claim 1, further comprising a vase or pot holder having a rectangular base wherein said grooves are spaced so as to form said slot so as to receive the extended edge of said base; whereby a plurality of said vase or pot holders may have their respective bases inserted one by one into and slid along said slot to form row of said vase or pot holders.

7. The floral transport system of claim 6, wherein said vase or pot holders comprise a vertically disposed tubular wall extending vertically upward from a central mounting on said base.

8. The floral transport system of claim 7, wherein said vertically disposed tubular wall has diametrically opposed slots extending downward through said tubular wall so as to receive a handle or other protrusion from said vase or pot.

9. The floral transport system of claim 8, wherein said diameter of said slots is perpendicular to said base unit rails.

10. The floral transport system of claim 7, further comprising a removable vase spacer located between said tubular wall and said pot or vase to secure said pot or vase within said tubular wall.

11. The floral transport system of claim 10, wherein said pairs of bores are so spaced as to allow said spacers to be inserted between each vase or pot holder so as to space the vase or pot holders and their floral arrangements.

12. The floral transport system of claim 11, wherein pairs of bores are spaced along said rail at a distance of one-half the space between said rods on said spacer, whereby each said vase or pot holder is located between a pair of spacers and a space is maintained between each of said vase or pot holders by their respective pair of spacers.

13. The floral transport system of claim 12, wherein said spacers are planar in configuration, each having an upper edge, a lower edge, and opposing ends, said rods extending downward from said lower edge, said spacers extending upward so as to separate said vase or pot holder and their contents.
